(19) United States
(12) Patent Application Publication
(10) Pub. No.: US 2007/0146347 A1
(43) Pub. Date: Jun. 28, 2007

(54) FLICK-GESTURE INTERFACE FOR HANDHELD COMPUTING DEVICES

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/682,874

(22) Filed: Mar. 6, 2007

Related U.S. Application Data
(63) Continuation of application No. 11/344,613, filed on Jan. 31, 2006.
(63) Continuation-in-part of application No. 11/344,612, filed on Jan. 31, 2006.
(60) Provisional application No. 60/673,927, filed on Apr. 22, 2005.
(60) Provisional application No. 60/717,591, filed on Sep. 17, 2005.
(60) Provisional application No. 60/850,551, filed on Oct. 10, 2006.

(51) Int. Cl. G09G 5/00

(52) U.S. Cl. 345/173

(57) ABSTRACT

A system is provided for wirelessly transferring at least one data file in response to a detection of a flick gesture performed by a user. An electronic device to receive at least one data file from a handheld computing device. The handheld computing device includes (a) a display to display an icon corresponding to the at least one data file; (b) a touch screen to detect that an area of the display associated with the icon corresponding to the at least one data file is touched by a finger of a user; (c) a processor to determine whether the flick gesture is performed by the user; and (d) a communication element to transfer the at least one data file from the handheld computing device to the electronic device in response to the detected flick gesture. The flick gesture comprises the user touching the icon with a finger and then sliding the finger quickly across the display in a motion that feels to the user as if he or she is flicking the icon off the screen and to the electronic device.

### RELATED APPLICATION DATA

This application is a continuation in part of co-pending U.S. patent application Ser. No. 11/344,613 (“the '613 application”) filed Jan. 31, 2006 and entitled “Method and Apparatus for Point-And-Send Data Transfer within a Ubiquitous Computing Environment” and hereby incorporates the aforementioned patent application by reference herein in its entirety; the '613 application claims priority to provisional patent application 60/673,927 filed Apr. 22, 2005, entitled “Method and Apparatus for Point-And-Send Data Transfer within a Ubiquitous Computing Environment,” the disclosure of which is incorporated by reference in its entirety; this application is also a continuation in part of co-pending U.S. patent application Ser. No. 11/344,612 (“the '612 application”) filed Jan. 31, 2006 and entitled “Pointing Interface for Person-to-Person Information Exchange” and hereby incorporates the aforementioned patent application by reference herein in its entirety; the '612 application claims priority to provisional patent application 60/717,591 filed Sep. 17, 2005, entitled “Pointing Interface for Person-to-Person Information Exchange,” the disclosure of which is incorporated by reference in its entirety; this application also claims priority to provisional application Ser. No. 60/850,551, filed Oct. 10, 2006, the disclosure of which is hereby incorporated by reference herein in its entirety.

### FIELD OF THE APPLICATION

The present invention relates to gesture recognition functions portable computing devices.

### BACKGROUND

At the present time, a great many electronic appliances reside in a typical home or office. The appliances are compliant to receive data files in standard formats, including music media files, video media files, image files, text files, word processing files, email files, text message files, database files, and/or other data files. In addition, at the present time a typical user maintains a handheld computing device on his or her person during much of his or her life. The handheld computing device is a personal digital assistant, media player, cell phone, timepiece, personal navigation device, and/or any combination of the aforementioned. Therefore, there are a growing number of situations in a person's daily life where the person may desire to transfer one or more data files from his or her handheld computing device to an electronic appliance within his or her local environment. For example, a user may wish to transfer a music file from the memory of his or her handheld computing device to a stereo electronic appliance in his or her home, or to a personal computer in his or her home, or even to a data store within an electronic appliance of his or her car. Similarly, movie files, image files, text files, and raw informational data files are often transferred by a user to one or more electronic appliances within his or her local environment. Unfortunately, a user must currently go through a complex series of steps to transfer data to desired target appliance. For example, to transfer a music file from a handheld computing device to a personal computer, a user must interface the two devices, select the file using the pointer of a GUI interface, and then drag and drop it into an iconic folder representation of the target device. Such a process is slow, cumbersome, and does not leverage the real physical world around the user. What is needed is a more natural method by which a user can transfer a data file from a handheld computing device to an electronic appliance in his or her local environment. What is further needed is a method that is physically intuitive and satisfying, giving the user a perceptual illusion that data is actually being propelled from his or her handheld computing device, across real physical space, to the target electronic appliance.

### SUMMARY

At least one embodiment of the invention is directed to a method for transferring at least one data file from a handheld computing device to an electronic device. The method includes detecting whether the handheld computing device is pointed in a direction of the electronic device, and whether an area of a touch screen of the handheld computing device associated a displayed icon corresponding to the at least one data file is touched by a finger of a user. The method further includes detecting that a flick gesture is performed by the user. The flick gesture comprises sliding the finger across the touch screen in a direction of the electronic device. Finally, the at least one data file is transferred from the handheld computing device to the electronic device.

At least one embodiment of the invention is directed to a handheld computing device for transferring at least one data file to an electronic device in response to detecting a flick gesture performed by a user. The handheld computing device includes a display to display an icon corresponding to the at least one data file. Pointing sensors detect that the handheld computing device is pointed in a direction of the electronic device A touch screen detector detects that an area of the display associated the icon corresponding to the at least one data file is touched by a finger of a user. A processor determines whether the flick gesture is performed by the user. The flick gesture comprises sliding the finger across the display in a direction of the electronic device. A communication element transfers the at least one data file from the handheld computing device to the electronic device.

At least one embodiment of the invention is directed to a system for wirelessly transferring at least one data file in response to a detection of a flick gesture performed by a user. An electronic device to receive at least one data file from a handheld computing device. The handheld computing device includes (a) a display to display an icon corresponding to the at least one data file; (b) a touch screen to detect that an area of the display associated the icon corresponding to the at least one data file is touched by a finger of a user; (c) a processor to determine whether the flick gesture is performed by the user, the flick gesture comprising sliding the finger across the display in a direction of the electronic device; and (d) a communication element to transfer the at least one data file from the handheld computing device to the electronic device.

The above summary of the present invention is not intended to represent each embodiment or every aspect of the present invention. The detailed description and figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates a handheld computing device according to at least one embodiment of the invention;

FIG. 2 illustrates a system block diagram showing the basic components of the handheld computing device according to at least one embodiment of the invention;

FIG. 3 illustrates the handheld computing device being pointed by a user in the general direction of an electronic appliance (B) according to at least one embodiment of the invention;

FIGS. 4A and 4B illustrate the beginning and end images, respectively, of a flick gesture in progress according to at least one embodiment of the invention; and

FIG. 5 illustrates a graphical trail displayed according to at least one embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Embodiments of the invention are directed to methods, apparatus, and computer program products for enabling a flick gesture interface for handheld computing devices. More specifically, embodiments of the present invention enable a user to send a file from a handheld computing device to an alternate electronic device by fingering an icon for the device and flicking the icon off the screen of the handheld device in the direction of the alternate electronic device. The result is a physically intuitive gestural interface where a user feels like he or she is physically flicking the file off of a handheld computing device, across empty space, and into the awaiting alternate electronic device. Such an intuitive gestural interface is compelling, satisfying, and easily understood by users. Embodiments of the present invention are enabled through a touch screen interface of the handheld computing device and a point-and-send computational architecture in which data files may be sent from a portable computing device to an electronic device by means of pointing the portable computing device in the direction of the electronic device. Sent data files may include music media files, image files, text files, message files, video files, and/or other common file formats.

Embodiments of the present invention provide a natural, intuitive, easy to use, and physically realistic interface method by which to command a data file to be transferred from a handheld computing device to a target electronic appliance. Furthermore, embodiments of the present invention provide a desired perceptual illusion for the user, making it feel as if the data file is a real physical object that is being propelled across empty space from the handheld computing device to the target electronic appliance.

Embodiments of the present invention comprise a handheld computing device equipped with a touch screen unit for visual image display to the user and manual input collection from the user. The touch screen display may be engaged by a finger or stylus, depending upon the type of components used, but for the sake of simplicity it refers primarily to finger interaction as discussed herein, without precluding the use of a stylus in certain embodiments. Embodiments of the present invention provide a unique user interface system in which a user can select a data file by placing his finger upon a graphical icon relationally associated with the data file, where the graphical icon displayed upon the touch screen display, and then cause the data file to be sent to an external electronic appliance in the user's local environment by flicking the icon with his or her finger, off the screen, and in the direction of the target external electronic appliance. In this way the user is given a perceptual illusion that he or she is physically propelling the data file, the way he or she might flick a coin with his finger, off the screen surface of the handheld computing device, across empty space, and into the target electronic appliance. In common embodiments the process generally includes a two-step operation where the handheld computing device is first pointed in the direction of the target electronic appliance by a first hand of the user (i.e., the support hand that is holding the handheld computing device) and then the desired data file is selected and sent by a user putting his or her finger upon the icon relationally associated with the data file and flicking it off the screen, in the direction of the target electronic appliance.

Embodiments of the present invention include an architecture and related computational infrastructure such that a target electronic appliance may be selected from among a plurality of possible electronic appliances by a user of a handheld computing device. Once selected, a desired data file may be transmitted from the handheld computing device over a communication link to the target electronic appliance. Thus, embodiments of the present invention require hardware and software such that a target electronic appliance within a local environment may be identified and selected by the user of the handheld computing device as well as hardware and software such that data can be wirelessly communicated from the handheld computing device to the selected target appliance. A variety of architectures may be used to enable such functions. One effective metaphor for allowing a user of a handheld computing device to select and send data to one of a plurality of different appliances within his or her local environment is through pointing direction as is disclosed in detail in co-pending U.S. patent application Ser. Nos. 11/344,613 and 11/344,612 by the present inventor, both of which are incorporated herein by reference. In such a system, a user points a handheld computing device in the direction of a target appliance and then engages a physical and/or graphical button of the handheld computing device to select and send a data file to the target appliance. The target appliance may be a computer, media player, TV player, stereo, digital picture frame, and/or any other electronic device within the user's environment that is configured to accept data files in one or more formats. In some embodiments the handheld computing device must be within certain proximity of the target electronic appliance for selection and data transfer to be enabled. In other embodiments selection is made based at least in part upon which appliance from among a plurality of local appliances is within closest proximity to the handheld computing device of the user. In this way a user of a handheld computing device may easily select a target appliance within his or her local environment by simply pointing at and/or coming within close proximity to the target appliance.

A natural and intuitive means of physical interaction is provided, enabling a user of such a system to feel as though he or she is physically propelling the selected data file in the direction of the target appliance. Thus, in addition to pointing the handheld computing device in the direction of a target appliance and/or coming within close proximity of the target appliance (so as to select the target appliance), a unique and compelling flick gesture interface is hereby disclosed as a means of selecting and sending a particular data file to the target electronic appliance.

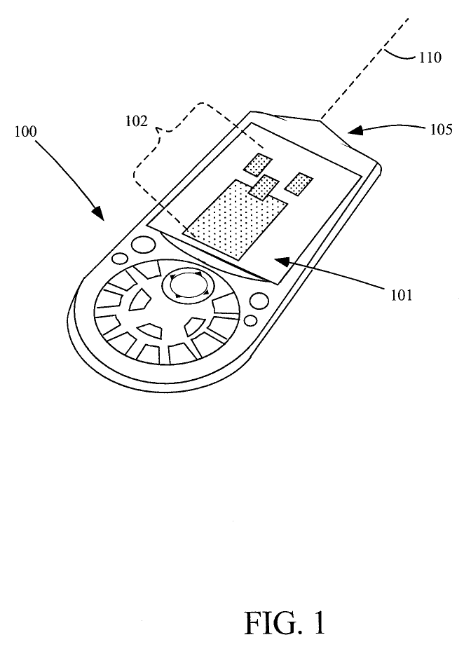

FIG. 1 illustrates a handheld computing device 100 according to at least one embodiment of the invention. The handheld computing device 100 includes a handheld casing that may be pointed in a general direction by a user. To support such pointing the device 100 generally includes a physically determinable pointing end 105 that aims away from the user when the device 100 is comfortable held within a hand or hands. In this example, the pointing direction of the handheld computing device 100 is represented by dotted line 110. In some embodiments the handheld computing device 100 includes one or more locative sensors (not shown) for determining the position and/or orientation of the handheld computing device 100 within the local environment of the user. The locative sensors may include, for example, a GPS transducer and/or a magnetometer for detecting the position and orientation of the unit as held by the user within the real physical world. In other embodiments the handheld computing device 100 may include an emitter and/or detector of electromagnetic radiation for determining if the device is pointing in the direction of a target electronic appliance, for example an IR emitter and/or laser emitter and/or detector. Thus, embodiments of the present invention may be configured to determine successful pointing at a target electronic device based upon the sensed location and/or orientation of the unit within the environment and/or based upon line-of-site transmission between emitters and detectors. Details of both methods are disclosed in co-pending U.S. patent application Ser. Nos. 11/344,613 and 11/344,612 by the present inventor, both of which are hereby incorporated by reference in their entirety.

Handheld computing device 100 also includes a touch screen 101 which functions both as an output of visual content and an input for manual control. A traditional touch screen interface enables a user to provide input to a graphical user interface (“GUI”) 102 by manually touching the surface of the screen as a means of targeting and selecting displayed graphical elements. In general, simulated buttons, icons, sliders, and/or other displayed elements are engaged by a user by directly touching the screen area at the location of the displayed user interface element. For example, if a user wants to target and select a particular icon, button, hyperlink, menu element, or other displayed element upon the screen, the user touches the actual location upon the screen at which that desired element is displayed. Some touch screen systems enable more complex interactions, such as bi-modal finger engagement as is disclosed in co-pending U.S. Patent Application Ser. No. 60/786,417 by the present inventor, the disclosure of which is hereby incorporated by reference. Other touch screen systems have been disclosed in pending U.S. patent applications that enable multi-finger control, including Ser. No. 10/840,862 and Publication Nos. 2006/0026521 and 2006/0022955, all of which are hereby incorporated by reference.

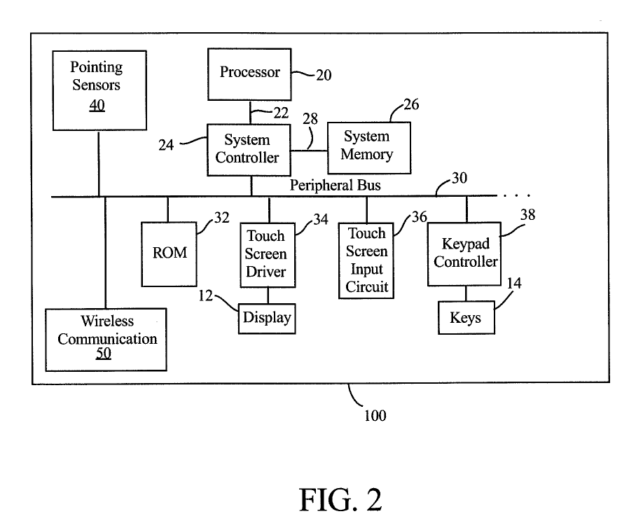

FIG. 2 illustrates a system block diagram showing the basic components of the handheld computing device 100 according to at least one embodiment of the invention. The computer 100 includes a processor 20 of conventional design that is coupled through a processor bus 22 to a system controller 24. The processor bus 22 generally includes a set of bidirectional data bus lines coupling data to and from the processor 20, a set of unidirectional address bus lines coupling addresses from the processor 20, and a set of unidirectional control/status bus lines coupling control signals from the processor 20 and status signals to the processor 20. The system controller 24 performs two basic functions. First, it couples signals between the processor 20 and a system memory 26 via a memory bus 28. The system memory 26 may typically a dynamic random access memory (“DRAM”), but it may also be a static random access memory (“SRAM”). Second, the system controller 24 couples signals between the processor 20 and a peripheral bus 30. The peripheral bus 30 is, in turn, coupled to a read only memory (“ROM”) 32, a touch screen driver 34, a touch screen input circuit 36, and a keypad controller 38. The peripheral bus 30 is also coupled to pointing sensors 40, which enable the processor, alone or in combination with an external processor, to determine if and when the portable computing device is pointing at a target electronic appliance. Pointing sensors 40 may include spatial sensors such as, for example, Global Positioning System (“GPS”) transducers and/or magnetometers. Pointing sensors 40 may include emitter and/or detector components, for example IR and/or visible light emitters and/or detectors for determining line-of-sight alignment with a target electronic appliance. The peripheral bus 30 is also coupled to a wireless communication unit 50 that enables wireless data transfer with one or more target electronic appliances. The wireless communication unit 50 may comprise wi-fi communication components, Bluetooth communication components, cellular communication components, and/or components to support any prevailing standard in wireless communication of data. The wireless communication unit 50 may communicate directly with one or more target electronic appliances and/or may communicate with target electronic appliances through an intervening network such as a LAN and/or the Internet and/or a Bluetooth ad hock network.

The ROM 32 stores a software program for controlling the operation of the computer 100, although the program may be transferred from the ROM 32 to the system memory 26 and executed by the processor 20 from the system memory 26. The software program may include the specialized routines described herein for enabling the flick-gesture features in which a data file may be sent to a target electronic appliance through a physical flick imparted by the user upon the touch screen 101. These routines may be implemented in hardware and/or software and may be implemented in a variety of ways. In general, the routines are configured to determine when a user desires to send a particular data file from a plurality of data files stored upon the handheld computer 100, to a particular target electronic appliance from among a plurality of electronic appliances within the environment of the user. The routines determine this user desire based upon the detection of a flick gesture, the flick gesture being imparted upon a particular one of said plurality of data files, the flick gesture being such that the user touches at least part of a graphical element that is relationally associated with the particular one of said plurality of data files and physically flicks it off the screen in the general direction of the particular target electronic appliance. In a common embodiment the handheld computing device is held such that the pointing portion 105 of the handheld computing device 100 is aimed generally in the direction of the target electronic appliance, and the flick gesture is generally determined as a physical flick wherein the graphical element that is relationally associated with the particular data file is rapidly propelled towards and off the edge of the touch screen 101 that is closest to the pointing portion 105 of the handheld computing device 100.

In a preferred embodiment, a flick gesture is enabled in which a user touches a finger to the touch screen 101 of handheld computing device 100 at a location that is over or upon a graphical element that is relationally associated with a particular data file, and then flicks his or her finger, with continuous contact upon the touch screen 101, towards and off the edge of the side of touch screen 101 that is closest to pointing portion 105 of handheld computing device 100. Because the pointing portion 105 of handheld computing device 100 has been aimed generally by the user in a direction of a target electronic appliance, the user performing the flick gesture experiences a convincing illusion that he or she is physically flicking the data file off the screen of the handheld computing device 100, across empty space, and into the target electronic appliance. The directional alignment does not need to be perfect to instill the perceptual illusion, but merely must be generally in the desired direction. Thus, a user who aims handheld computing device 100 in the general direction of a target electronic appliance and then performs a flick gesture in which the graphical element associated with a desired data file is touched and flicked off the side of the screen that is closest to the pointing portion 105 of the handheld computing device, is made to feel perceptually as if he flicked the file off the handheld computing device and into the target electronic appliance. As the user performs the flick gesture upon the graphical element, such as an icon or folder or window, the element is generally moved upon the display screen by GUI drivers such that it quickly slides across the screen and then disappears when it reaches the edge of the screen. This enhances the physical illusion of the flick gesture.

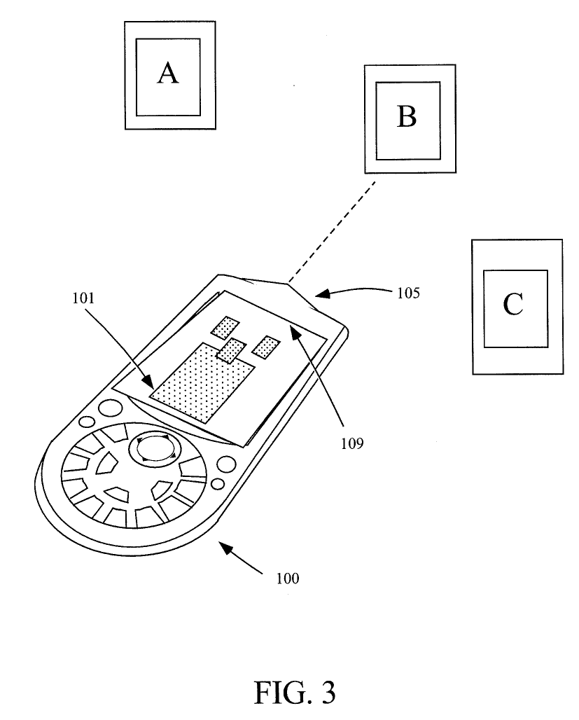

FIG. 3 illustrates the handheld computing device 100 being pointed by a user in the general direction of an electronic appliance (B) according to an embodiment of the invention. This is achieved by aiming the pointing portion 105 of the handheld computing device 100 in the general direction of electronic appliance (B) while the touch screen 101 is maintained visible to the user as shown. Also shown are other electronic appliances (A) and (C) that are not being pointed at by the handheld computing device 100. In this way a user may target electronic appliance B from among the plurality of electronic appliances A, B, and C. By virtue of the pointing metaphor, one edge 109 of touch screen 101 of handheld computing device 100 is closest to the pointing portion 105 of handheld computing device 100, and closest to the target electronic appliance B. For clarity, this edge 109 of touch screen 101 is referred to herein as the “pointing edge” of the touch screen. In general, it is located at the edge furthest away from the user and nearest to the “top” of the computing device as it is perceived by the user.

Pointing portion 105 of handheld computing device 100 is aimed at target electronic appliance B, thereby positioning the pointing edge 109 of touch screen 101 such that it is the closest edge of the screen to electronic appliance B as perceived by the user. The user may subsequently perform a flick gesture upon touch screen 101 by fingering a graphical element that is relationally associated with a desired data file and then flicking it, by dragging it quickly in a flick-like motion towards and off the pointing edge 109 of touch screen 101. In response to this unique flick gesture upon the graphical element, the routines of embodiments of the present invention transmit the data file that is relationally associated with the flicked graphical element, from the handheld computing device 100 to the electronic appliance B over an intervening wireless communication link. In this way the user is made to feel perceptually as though he or she physically flicked the data file off the handheld computing device and into the target electronic appliance.

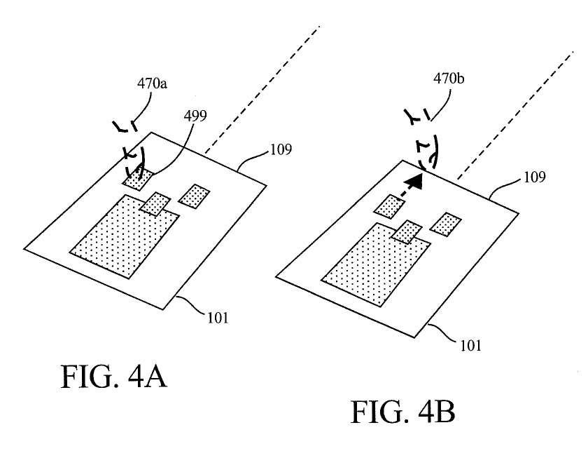

FIGS. 4A and 4B illustrate the beginning and end images, respectively, of a flick gesture in progress according to at least one embodiment of the invention. FIG. 4A represents the flick gesture at a first moment in time that corresponds to a user first engaging a target graphical element 499 with his finger 470A as one might normally do with a touch screen interface. At this moment in time the user touches the graphical element 499 by placing the tip or pad of his or her finger 470A over at least a portion of the graphical element. In this example, the graphical element is an element that is relationally associated with a particular data file. The graphical element might be a typical icon, folder, window, or other graphical representation that indicates that the element is relationally associated with a particular data file (or group of data files, for example in the case of a folder). Thus the user may select this particular data file (or particular group of data files) by simply touching the graphical element 499, thereby identifying the desired data file(s) from among a plurality of other data files that may be associated with other graphical elements upon the screen. Once the user has touched the target graphical element, he or she performs the flick gesture in which he or she quickly drags his or her finger in a flick-like motion towards and off the edge of the pointing edge 109 of touch screen 101. The resulting position of the user's finger is shown in FIG. 4B as finger location 470B. Thus, the user performs the flick-gesture by quickly moving his finger, while remaining in contact with touch screen 101, from position 470A to position 470B. The routines of embodiments of the present invention are configured to determine that a flick gesture has been performed based upon the detected finger contact location upon the touch screen 101, having been moved from a first location 470A that may be anywhere upon the screen so long as it identifies a graphical element associated with one or more data files, to a second location 470B that is determined to be just off the pointing edge 109 of the touch screen 101. The portable computing device generally cannot detect the user's finger once it has left the touch screen, therefore the fact that the user's finger has traveled from the first location 470A to the second location 470B that is off the pointing edge 109 of touch screen 101 is determined based upon the trajectory of the finger tracking data reported by the touch screen. The trajectory data of a flick gesture will show the finger tracked from the first location 470A towards the pointing edge 109 with a direction and speed that implies that the finger continued off the edge. Because of sampling rates, the last sample of tracking data may not be exactly at the edge but based upon the speed and direction, the routines of the present invention can still determine with reasonable accuracy if a flick gesture was performed.

In general, a flick gesture is also determined based upon timing information, where the flick gesture is performed such that the finger moves from the first location 470A to the second location 470B that is off the pointing edge 109, in a time period that is less than a predefined threshold. Because a flick gesture of a human, such as a flick a person might perform to fling a coin across a table, is a very quick gesture, the predefined threshold is generally small to ensure the perceptual illusion that a user is in fact flicking the data file off the handheld computer 100 to the target electronic appliance. In some embodiments the threshold is defined based upon the size of the screen and/or the distance of the graphical element from the pointing edge 109 of the screen. In one example embodiment where the screen is generally the size that fits in the palm of a user's hand, the predefined time threshold is 700 milliseconds. Thus, a flick gesture is determined if a user's finger is tracked to target a graphical element associated with a data file and slide it off the pointing edge 109 of the touch screen 101 in a time period that is less than 700 milliseconds. In other embodiments a velocity threshold is used instead of or in addition to a speed threshold, the velocity threshold defining the minimum velocity at which the user must slide his or her finger for it to qualify as a flick gesture. Again, the flick is a very quick motion that is generally much faster than how a user would normally position graphical elements during a typical drag and drop operation in a touch screen GUI interface.

In this way the trajectory data can be processed by the routines of embodiments of the present invention based upon both the direction of travel and the speed of travel of the finger contact location to determine if the user in fact performed a flick gesture upon the graphical element, quickly sliding it towards and off the pointing edge 109 of the touch screen. If so, the routines are configured to transfer the contents of the data file (or files) that are relationally associated with the fingered graphical element from the handheld computing device 100 to the targeted electronic appliance over an intervening communication network. In some embodiments the graphical element is removed from the screen to indicate visually that it has been transferred. In some embodiments the transferred data may be a copy of the selected data file, and a copy resides upon the handheld computing device. This is because when a user sends a data file to a target electronic device, such as a media player, an alternate portable computing device, a desktop computing device, a digital picture frame, or other similar device, the user generally wants to still keep a copy of the data file (or files) upon the portable computing device.

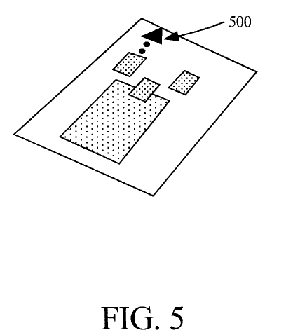

In some embodiments a graphical trail or arrow is displayed upon the screen of the portable computing device after a successful flick gesture to confirm for the user that it has in fact been sent to the target electronic appliance. FIG. 5 illustrates a graphical trail 500 displayed according to at least one embodiment of the invention. This graphical trail 500 may only displayed for a period of time or until the user next touches the touch screen surface.

Thus, embodiments of the present invention enable a user to indicate that a particular file (or set of files) is to be sent from a handheld computing device 100 to a target electronic appliance by pointing the handheld computing device 100 generally in the direction of the target electronic appliance (generally with a first hand) and then by fingering and flicking (generally with a second hand) a graphical element 499 that is relationally associated with the particular file (or set of files) towards and off the pointing edge 109 of the touch screen 101. In general, the flick gesture is determined by the routines based upon the sliding trajectory of the finger motion upon the touch screen having a trajectory that goes from a first location 470A towards a second location 470B that is off the edge of the pointing edge 109 of the touch screen 101. The flick gesture is also generally determined by the routines based upon the time of the sliding finger motion upon the touch screen having been below than a certain threshold and/or the speed of the sliding finger motion upon the touch screen having been above a certain threshold so as to further distinguish the flick gesture from a non-flick gesture. In these ways the routines provide a user with an interaction methodology that creates a perceptual illusion for the user such that it seems to the user that he or she is physically propelling the data file off the handheld computing device, across physical space, and to the target electronic device, with a natural and intuitive flick of the finger.

The foregoing described embodiments of the invention are provided as illustrations and descriptions. They are not intended to limit the invention to the precise forms described. In particular, it is contemplated that functional implementation of the invention described herein may be implemented equivalently in hardware, software, firmware, and/or other available functional components or building blocks.

This invention has been described in detail with reference to various embodiments. It should be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art.

Other embodiments, combinations and modifications of this invention will occur readily to those of ordinary skill in the art in view of these teachings. Therefore, this invention is not to be limited to the specific embodiments described or the specific figures provided. This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. A method for transferring at least one data file from a handheld computing device to an electronic device, comprising:
detecting that the handheld computing device is pointed generally in a direction of the electronic device;
detecting that an area of a touch screen of the handheld computing device associated with a displayed icon corresponding to the at least one data file is touched by a finger of a user;
detecting that a flick gesture is performed by the user with respect to the displayed icon, the flick gesture comprising sliding the finger across the touch screen in a general direction of the electronic device; and
transferring the at least one data file from the handheld computing device to the electronic device in response to the flick gesture.

2. The method of claim 1, further comprising detecting the flick gesture based on at least one of: an amount of time that the finger is sliding across the touch screen and a speed of the sliding of the finger across the touch screen.

3. The method of claim 2, wherein the amount of time is below a pre-determined threshold.

4. The method of claim 1, wherein the flick gesture comprises the user sliding the finger across the touch screen and off a physical edge of the touch screen.

5. The method of claim 1, wherein the detecting that the handheld computing device is pointed generally in a direction of the electronic device is performed at least in part using an emitter detector pair.

6. The method of claim 1, further comprising displaying a movement of the icon corresponding to the at least one data file is response to the detecting of the flick gesture.

7. The method of claim 6, further comprising displaying an arrow to indicate the movement of the at least one data file is response to the detecting of the flick gesture.

8. The method of claim 1, wherein the at least one data file comprises at least one of a music media file, an image file, a text file, a message file, and a video file.

9. The method of claim 1, wherein the transferring is performed wirelessly.

10. A handheld computing device for transferring at least one data file to an electronic device in response to detecting a flick gesture performed by a user, the handheld computing device comprising:
a display to display an icon corresponding to the at least one data file;
pointing sensors to detect that the handheld computing device is pointed generally in a direction of the electronic device;
a touch screen detector to detect that an area of the display associated with the icon corresponding to the at least one data file is touched by a finger of a user;
a processor to determine whether the flick gesture is performed by the user with respect to the icon, the flick gesture comprising sliding the finger across the display in a general direction of the electronic device; and
a communication element to transfer the at least one data file from the handheld computing device to the electronic device in response to the flick gesture.

11. The handheld computing device of claim 10, wherein the processor is adapted to determine if the flick gesture is performed based on at least one of: an amount of time that the finger is sliding across the display and a speed of the sliding of the finger across the display.

12. The handheld computing device of claim 11, wherein the amount of time is below a pre-determined threshold.

13. The handheld computing device of claim 10, wherein the flick gesture comprises the user sliding the finger across the touch screen and off a physical edge of the touch screen.

14. The handheld computing device of claim 10, wherein the display is adapted to display a movement of the icon corresponding to the at least one data file is response to the detecting of the flick gesture.

15. The handheld computing device of claim 14, wherein the display is further adapted to display an arrow to indicate the movement of the at least one data file is response to the detecting of the flick gesture.

16. The handheld computing device of claim 10, wherein the at least one data file comprises at least one of a music media file, an image file, a text file, a message file, and a video file.

17. The handheld computing device of claim 10, wherein the communication element is adapted to wirelessly transfer the at least one data file.

18. A system for wirelessly transferring at least one data file in response to a detection of a flick gesture performed by a user, the system comprising:
an electronic device to receive at least one data file; and
a handheld computing device having
a display to display an icon corresponding to the at least one data file;
a touch screen to detect that an area of the display associated with the icon corresponding to the at least one data file is touched by a finger of a user;
a processor to determine whether the flick gesture is performed by the user with respect to the icon, the flick gesture comprising touching the icon and sliding the finger across the display in a general direction of the electronic device; and
a communication element to transfer the at least one data file from the handheld computing device to the electronic device in response to the flick gesture.

19. The system of claim 18, wherein the handheld computing device further comprises pointing sensors to detect that the handheld computing device is pointed in a direction of the electronic device.

20. The system of claim 18, wherein the processor of the handheld computing device is adapted to determine if the flick gesture is performed based on at least one of: an amount of time that the finger is sliding across the display and a speed of the sliding of the finger across the display.

21. The system of claim 18 wherein the flick gesture comprises the user sliding the finger across the touch screen and off a physical edge of the touch screen.

22. The system of claim 18, wherein the display of the handheld computing device is adapted to display a movement of the icon corresponding to the at least one data file is response to the detecting of the flick gesture.

23. The system of claim 22, wherein the display of the handheld computing device is further adapted to display an arrow to indicate the movement of the at least one data file is response to the detecting of the flick gesture.

24. The system of claim 18, wherein the at least one data file comprises at least one of a music media file, an image file, a text file, a message file, and a video file.

25. A method for transferring at least one data file from a handheld computing device to a physically separate electronic device over a wireless link, comprising:
detecting that an area of a touch screen of the handheld computing device that is associated with the at least one data file is touched by a finger of a user;
detecting that a flick gesture is performed by the user with respect to the at least one data file, the flick gesture comprising touching the area associated with the at least one data file and then sliding the finger across the touch screen and off a physical edge of the touch screen, the touching and the sliding being performed as a continuous motion; and
transferring the at least one data file from the handheld computing device to the electronic device over the wireless link in response to the detecting of the flick gesture.

26. The method of claim 25, further comprising detecting that the handheld computing device is within a certain proximity of the electronic device.

27. The method of claim 25, further comprising detecting that the handheld computing device is pointed in a general direction of the electronic device.

28. The method of claim 25, wherein the flick gesture further requires that the finger is slid off a specific physical edge of the touch screen.

29. The method of claim 28, wherein the specific physical edge is an edge closer to the electronic device than another edge of the touch screen.

30. The method of claim 21, further comprising detecting the flick gesture based on at least one of: an amount of time that the finger is sliding across the touch screen and a speed of the sliding of the finger across the touch screen.

31. The method of claim 21, further comprising selecting the electronic device from a plurality of electronic devices based upon at least one of: a proximity of the handheld computing device to the electronic device, a pointing direction of the handheld computing device with respect to a location of the electronic device, and a receipt of an electromagnet emission from the electronic device.
